(19) United States
(12) Patent Application Publication
(10) Pub. No.: US 2025/0317935 A1
(43) Pub. Date: Oct. 9, 2025

(54) SYSTEMS, METHODS, AND DEVICES FOR UE-INITIATED BEAM INDICATION BASED ON UL CONFIGURED GRANT

(71) Applicant: Apple Inc., Cupertino, CA (US)

(72) Inventors: Haitong SUN, Saratoga, CA (US); Hong HE, San Jose, CA (US); Wei ZENG, Saratoga, CA (US); Ankit BHAMRI, Haar (DE); Dawei ZHANG, Saratoga, CA (US); Weidong YANG, San Diego, CA (US)

(21) Appl. No.: 19/171,126

(22) Filed: Apr. 4, 2025

Related U.S. Application Data
(60) Provisional application No. 63/575,580, filed on Apr. 5, 2024.

(51) Int. Cl. H04W 72/21; H04W 72/232

(52) U.S. Cl. CPC H04W 72/21; H04W 72/232

(57) ABSTRACT

The techniques herein include solutions for user equipment (UE) initiated beam reporting or indication based on an uplink (UL) configured grant (CG). A base station may send a UL CG to UE for beam reporting or indication. The UL CG may correspond to time and frequency resources of a physical UL shared channel (PUSCH) with transmission occasions. The UE may detect a preselected event for beam reporting or indication of one or more beams, and in response to the preselected event, may generate a beam report. The UE may communicate the beam report to the base station using the PUSCH during a transmission occasion. The beam report may include UL control information (UCI) with measurement information for one or more beams. The base station may receive the beam report, generate downlink (DL) feedback based on the beam report, and communicate the DL feedback to the UE.

### CROSS-REFERENCE TO RELATED APPLICATIONS

This application claims the benefit of U.S. Provisional Application No. 63/575,580, filed Apr. 5, 2024, the entire disclosure of which is herein incorporated by reference for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. One of many aspects of developing such technologies include managing beams, channels, and signals between a UE and a base station.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example process for UE-initiated beam indication based on uplink (UL) configured grant (CG) according to one or more implementations described herein.

FIG. 4 is a diagram of an example of UE-initiated beam indication and downlink (DL) feedback according to one or more implementations described herein.

FIG. 5 is a diagram of an example of transmission configuration indication (TCI) with quasi co-location (QCL) information according to one or more implementations described herein.

FIG. 6 is a diagram of an example of beam management (BM) UL control information (UCI) according to one or more implementations described herein.

FIG. 7 is a diagram of an example of DL feedback relative to UL CG transmission occasions according to one or more implementations described herein.

FIG. 8 is a diagram of an example of DL feedback relative to UL CG transmission occasions according to one or more implementations described herein.

FIG. 9 is a diagram of an example process for UE-initiated beam indication based on a UL CG according to one or more implementations described herein.

FIG. 10 is a diagram of an example process for UE-initiated beam indication based on a UL CG according to one or more implementations described herein.

FIG. 11 is a diagram of an example of components of a device according to one or more implementations described herein.

FIG. 12 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include processes, operations, configurations, and information for beam management.

Beam management may include beam measurement and reporting, beam indication, and beam failure and recovery. Beam measurement and reporting may involve a UE measuring characteristics relating to the state or quality of a beam and reporting the measured characteristics to a base station. Beam indication may include a base station indicating one or more downlink (DL) or uplink (UL) channels or signals to a UE. Beam failure recovery may include a channel or signal between a base station and UE failing to operate as a reliable transmission medium and operating to restore the same or a different channel or signal. A beam may refer to a channel, signal, or another type of wireless resource that enables wireless communication.

Beam management may involve a transmission configuration indication (TCI) signaling framework where a beam for a target channel (e.g., a physical DL shared channel (PDSCH), physical DL control channel (PDCCH), channel state information (CSI) reference signal (CSI-RS), etc.) may be indicated by a TCI. Transmission configuration indicator (TCI) may include a signaling mechanism used to inform a UE about the current configuration of DL transmission parameters. TCI may include a source reference signal (RS) and an intended quasi co-location (QCL) type to be applied. For example, a base station may schedule UE for a PDSCH by sending the UE DL control information (DCI) that includes the TCI for the PDSCH. The UE may self-configure analog beamforming coefficients based on the TCI. For a PDCCH or a CSI-RS, different signaling (e.g., radio resource control (RRC) signaling, media access control (MAC) control element (MAC-CE) signaling, etc.) may be used for beam indication. Unified TCI can be also applied to UL channel/signal.

Beam indication techniques that involve using one TCI to schedule a single DL or UL channel or signal may be referred to as an individual TCI framework. Beam indication techniques that involve using a set of TCIs (also referred to as a unified TCI (uTCI)) to schedule multiple DL or UL channels or signals may be referred to as a uTCI framework. A uTCI framework may be implemented in a 1st mode or a 2nd mode. The 1st mode may be referred to as joint TCI and may involve one TCI being applied to both DL and UL channels or signals. The 2nd mode may be referred to as separate TCI, where a DL TCI may be used for indicating multiple DL beams, and a UL TCI may be used for indicating multiple UL beams.

TCI state indication may include a first TCI state indication scheme (scheme 1) or a second TCI state indication scheme (scheme 2). Scheme 1 may include a common TCI indication for multiple UL or DL channels or signals. The common TCI may be applied to a dedicated PDCCH, PDSCH, PUCCH, and PUSCH. The common TCI may be optionally applied to aperiodic CSI-RS for beam management CSI, sounding reference signal (SRS) for cellular band beam management, non-cellular band beam management, and access stratum (AS) beam management. Whether a common TCI is applied to a channel or signal may be configured by RRC. Scheme 2 may include a dedicated TCI indication for one channel or reference signal. For example, scheme 2 may be applied to signals that are not subject to a common TCI indication (e.g., scheme 1).

In summary, scheme 1 may be applied to a dedicated PDSCH, PDCCH, PUSCH, and PUCCH. Scheme 1 or scheme 2 may be applied to a common PDSCH for intra-cellular beam management, a common PDCCH for intra-cellular beam management, or an aperiodic CSI-RS for beam management CSI. Scheme 2 may be applied to a periodic CSI-RS, a semi-persistent CSI-RS, an aperiodic CSI-RS for tracking, a common PDSCH for inter-cell beam management, or a common PDSCH for inter-cell beam management.

A base station may allocate time and frequency resources for downlink (DL) and uplink (UL) communications via a configured grant (CG) or a dynamic grant (DG). A base station may provide a UE with a DG for UL resources in response to a request from the UE. A base station may provide a UE with a CG for UL resources without a request from the UE. The time and frequency resources, periodicity, etc., of a CG may be based on the a corresponding type of service or signaling. A UL CG may be a type 1 CG or a type 2 CG. A type 1 CG may be activated and deactivated using RRC signaling. A type 2 CG may be activated and deactivated using DCI signaling.

Currently available techniques fail to provide any, or adequate, solutions for beam management by failing to enable a UE to proactively engage in beam reporting in a manner that uses time and frequency resources efficiently. Beam reporting (or beam indication) may include a UE providing a base station with one or more types of information relating to the status, condition, or quality of a beam, channel, or signal. The information may include measurements performed by the UE, and the reported beam, channel, or signal may be associated with the base station serving the UE, another base station, another type of network access point, or another UE. One or more of the techniques described herein may enabling beam reporting or indication via a UL CG that includes PUSCH resources with transmission occasions.

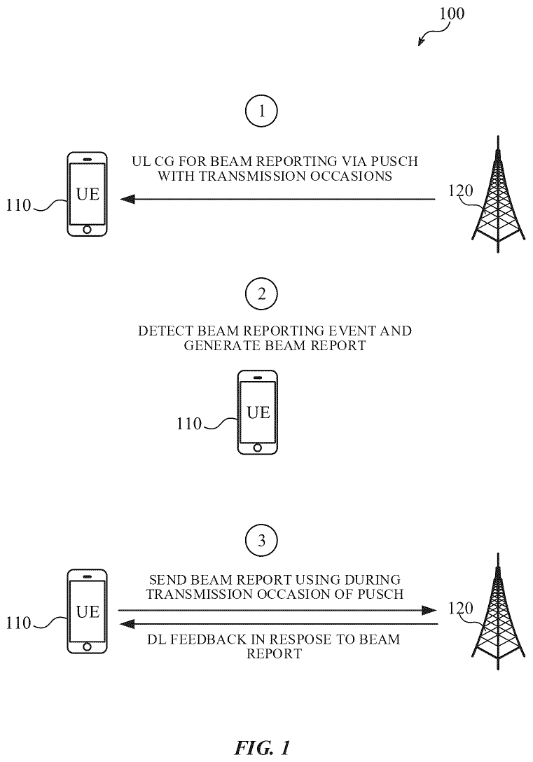

FIG. 1 is a diagram of an example of an overview 100 according to one or more implementations described herein. As shown, overview 100 may include UE 110 and base station 120. Base station 120 may send a UL CG to UE 120 for beam reporting/indicating (at 1). The UL CG may include time and frequency resources of a PUSCH with transmission occasions. In some implementations, base station 120 may also send configuration information to UE 120 for monitoring or measuring one or more beams associated with base station 120 or another device, such as beams of neighboring base stations (not shown). UE 120 may detect a preselected event for beam reporting or indication, and in response to the preselected event, may generate a beam report (at 2). The beam report may include UL control information (UCI) with measurement information for one or more beams. UE 210 may communicate the beam report to base station 222 using the PUSCH during a transmission occasion, and base station 222 may receive the beam report, generate DL feedback based on the beam report, and communicate the DL feedback to UE 210 (at 3). The DL feedback may serve as a confirmation of whether the base station acknowledges the beam report. These and other features, are described in additional detail with reference to remaining Figures.

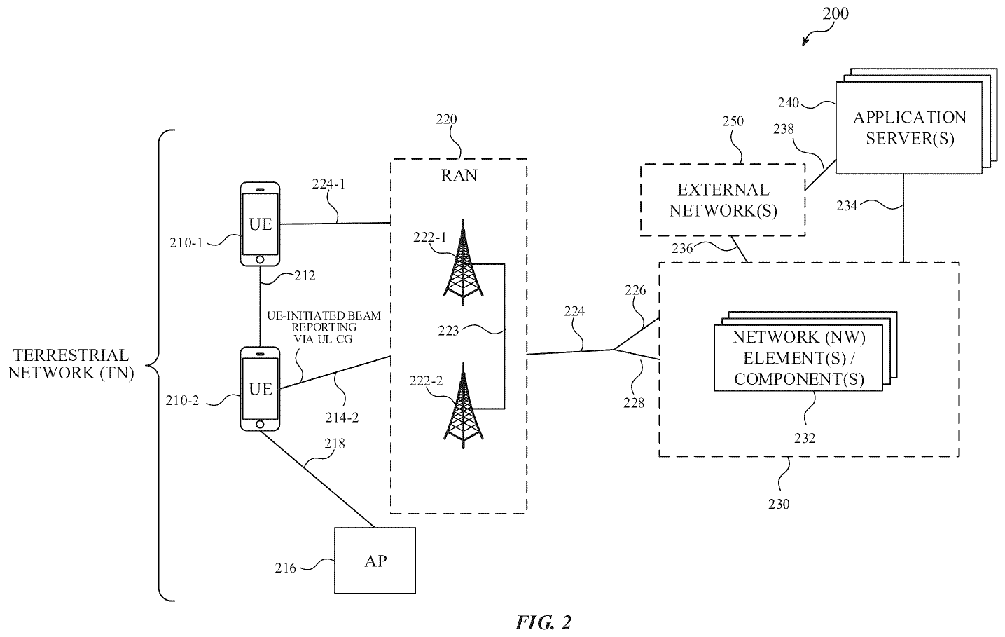

FIG. 2 is an example network 200 according to one or more implementations described herein. Example network 200 may include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210 may communicate with RAN node 222 to request SL resources. RAN node 222 may respond to the request by providing UE 210 with a dynamic grant (DG) or configured grant (CG) regarding SL resources. A DG may include a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

As described herein, UE 210 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements (REs). Each resource block may comprise a collection of resource elements; in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

One or more of the techniques described herein may enable UE-initiated beam reporting or indication using a UL CG. Base station 222 may send the UL CG to UE 210 for beam reporting/indicating. The UL CG may correspond to time and frequency resources of a PUSCH with transmission occasions. UE 210 may detect a preselected event for beam reporting or indication, and in response to the preselected event, may generate a beam report. UE 210 may communicate the beam report to base station 222 using the PUSCH during a transmission occasion. The beam report may include UCI with measurement information for one or more beams. Base station 222 may receive the beam report, generate DL feedback based on the beam report, and communicate the DL feedback to UE 210. Many other aspects and examples are also described herein.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

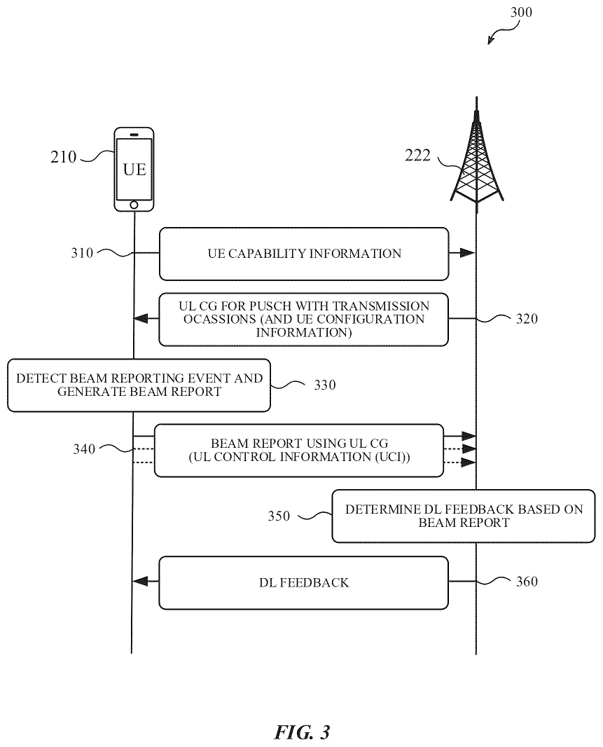

FIG. 3 is a diagram of an example process 300 for UE-initiated beam indication based on a UL CG according to one or more implementations described herein. Process 300 may be implemented by UE 210 and one or more base stations 222. In some implementations, some or all of process 300 may be performed by one or more other systems or devices, including one or more of the devices of FIG. 2. Additionally, process 300 may include one or more fewer, additional, differently ordered and/or arranged operations than those shown in FIG. 3. In some implementations, some or all of the operations of process 300 may be performed independently, successively, simultaneously, etc., of one or more of the other operations of process 300. As such, the techniques described herein are not limited to a number, sequence, arrangement, timing, etc., of the operations or processes depicted in FIG. 3.

As shown, UE 210 may communicate UE capability information to base station 222 (at 310). The UE capability information may indicate an ability of UE 210 to engage in beam management. Examples of such capabilities may include beam monitoring and measuring capabilities, beam reporting capabilities, transmission and reception capabilities, TCI states and/or TCI state frameworks supported by UE 210, and more.

Base station 222 may communicate a UL CG to UE 210 (at 320). Base station 222 may generate a UL CG for allocating the resources and may send the UL CG to UE 210. The UL CG may include time and frequency resources of a PUSCH. The UL CG may include a number, periodicity, and duration of transmission occasions for the PUSCH resources. Base station 222 may also communicate UE configuration information to UE 210. The UE configuration information may indicate one or more beams, channels, or signals to be monitored or measured by UE 210. The UE configuration information may also indicate one or more events, triggers, or conditions to be monitored by UE 210. The UE configuration information may also include one or more parameters, thresholds, or other types of information or instructions for operating in accordance with the techniques described herein. Examples of such information may include a unified TCI state, joint TCI state, DL unified TCI, UL unified TCI, etc. The UL CG and the UE configuration information may be communicated together or separately, and may involve RRC signaling, DCI signaling, a MAC-CE, or another type of signaling.

In some implementations, a UL CG for UE-initiated beam indication, as described herein, may be a type 1 UL CG, a type 2 UL CG, or either a type 1 or a type 2 UL CG. For example, in some implementations, the UL CG for UE-initiated beam indication may be activated and deactivated by RRC signaling. In other implementations, the UL CG for UE-initiated beam indication may be activated and deactivated by DCI signaling. In yet other implementations, both RRC signaling and DCI signaling may be used for either CG activation or CG deactivation.

UE 210 may detect a beam reporting event and generate a beam report (block 330). The beam reporting event may be a preselected event. A preselected event may include an event or condition indicated by configuration information provided by base station 210 or stored locally by UE 210 (based on an existing communication standard). A preselected event may include an occurrence of one or more conditions relating to a beam, channel, or signal (e.g., an RSRP, SINR, etc.). The condition may relate to a beam characteristic, measured or detected by UE 210, falling below, equaling, or exceeding a corresponding threshold. UE 210 may generate a beam report in response to detecting the preselected event. The beam report may identify or indicate one or more beams and/or a status or one or more characteristics of a beam.

UE 210 may communicate the beam report to base station 222 using the UL CG (block 340). The beam report may be communicated using the time and frequency resources of the PUSCH during a transmission occasion defined by the UL CG. The beam report may include UCI. UCI used for beam management may be referred to as beam management (BM) UCI (BM-UCI). The UCI may include a beam indicator, a HARQ process number, a redundancy version (RV) value, beam quality indicator, a capability index value, and more. The beam report may also indicate the beam, beam type, and/or preselected event corresponding to the beam report. UE 210 may communicate the entire beam report during a single transmission occasion or over multiple transmission occasions. UE 210 may retransmit the beam report until DL feedback is received. In some implementations, so long as DL feedback is not received, UE 210 may retransmit the beam report until a maximum number of beam report retransmissions has been reached.

Base station 222 may determine DL feedback based on the beam report (block 350). Base station 222 may also communicate the DL feedback to UE 210 (block 360). For example, in response to receiving the beam report from UE 210, base station may generate DL feedback. The DL feedback may include an acknowledgement or confirmation that base station 222 received the beam report. The DL feedback may include an indication of the beam report or UL transmission associated with the beam report (e.g., the transmission occasion) so that UE 210 may determine the beam report to which the DL feedback corresponds.

In some implementations, the DL feedback may include additional information, such as instructions or configuration information that may cause or enable UE 210 to engage in beam failure recovery, switch to another beam, channel, or signal, etc. The DL feedback may also, or alternatively, include acknowledgment of the reception of the UE triggered/event driven beam report, or a configuration of measurement resource and measurement event for UE to perform beam refinement, etc. As the DL feedback may function as an acknowledgement of base station 222 having received the beam report, UE 210 may respond to receiving the DL feedback by canceling a subsequent retransmission of the beam report. Additionally, or alternatively, UE 210 may respond to the DL feedback by changing the active beam used for communication, or performing additional beam measurement. Example process 300 may further include one or more, or any combination, of additional features, operations, or alternatives, described in reference to the Figures and examples below.

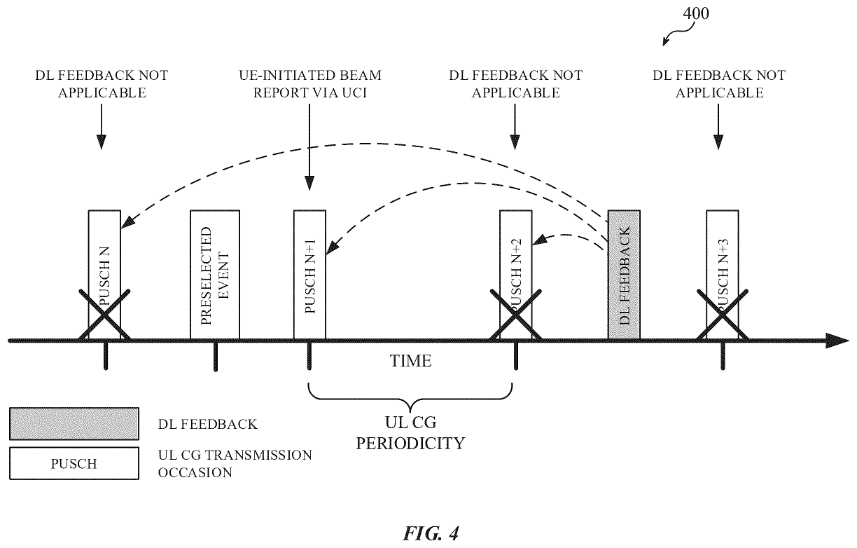

FIG. 4 is a diagram of an example 400 of UE-initiated beam indication and DL feedback according to one or more implementations described herein. As shown, example 400 may include time represented along a horizontal axis, PUSCH transmission occasions N though N+3, a preselected event between PUSCH N and PUSCH N+1, and DL feedback between PUSCH N+2 and PUSCH N+3. PUSCH transmission occasions N though N+3 may be spaced according to a UL CG periodicity. PUSCH transmission occasions N though N+3, and the UL CG periodicity therebetween, may represent a UL CG provided by base station 222 to UE 210.

For purposes of explaining example 400, assume that base station 222 provided UE 210 with the depicted UL CG. UE 210 detects a preselected event between transmission occasion N and N+1. Examples of the preselected event may be a change in signal quality, RSRP, SINR, etc., beyond a preselected threshold. UE 210 may respond to the event by generate a beam report corresponding to detecting the preselected event and sending the beam report to base station during UL CG transmission occasion N+1. The beam report may include UCI. Base station 222 may receive the beam report and prepare DL feedback in response to the report.

Base station 222 may communicate the DL feedback to UE 210. As shown, the DL feedback may confirm receipt of the beam report sent during transmission occasion N+1. The DL feedback may confirm receipt by, for example, including an indicating of preselected event detected, the transmission occasion used to send the beam report, PUSCH resources used to send the beam report, and/or by including one or more other types of information. In some implementations, the DL feedback may confirm receipt of the beam report by using DL resources associated with transmission occasion N+1. As such, UE 210 may determine that the beam report was received by base station 222 based on the DL feedback.

In some implementations, UE 210 may generate and communicate a beam report to base station 222 in response to detecting a preselected event. In other implementations, UE 210 may generate and communicate a beam report to base station during each transmission occasion of a UL CG (e.g., regardless of whether a preselected event has been detected). Additionally, or alternatively, UE 210 may communicate a beam report (e.g., UCI) regardless of whether UE 210 has UL data (e.g., a transport block (TB), UL shared channel (UL-SCH) information, etc.) to also send during the same UL CG transmission occasion. In other implementations, UE 210 may only communicate a beam report (e.g., UCI) when UE 210 has UL data to send during the same UL CG transmission occasion.

In some implementations, UE 210 may generate UCI for a beam report and UCI for the UL CG, and UE 210 may communicate both the beam report UCI and the CG-UCI to base station 222 during a UL CG transmission occasions. In some implementations, UE 210 may be configured to always report beam report UCI and CG-UCI together. In other implementations, UE 210 may be configured to report beam report UCI with or without CG-UCI.

In some implementations, UE 210 may generate UCI for a beam report and UCI for unused transmission occasions (UTO) (UTO-UCI). UTO-UCI may indicate one or more CG UL transmission occasions that were not used and/or portions (or resources) of one or more CG UL transmission occasions that were not used. In some implementations, UE 210 may be configured to always report beam report UCI and UTO-UCI together (e.g., even when there were no unused transmission occasions). In other implementations, UE 210 may be configured to report beam report UCI with or without UTO-UCI.

Base station 222 may configure UE 210 with a list of unified TCI states for measurement. This may be included in a UL CG or UE configuration information. For a joint TCI mode or scenario, a list of unified TCI states may be chosen from a dl-OrJointTCI-StateList-r17 data structure of a PDSCH-Config information element (IE). For a separate TCI mode or scenario, a list of unified TCI states may be chosen from only DL unified TCIs (e.g., from TCIs from dl-OrJointTCI-StateList-r17 data structure of a PDSCH-Config IE). In other implementations, a list of unified TCI states for a separate TCI mode may be chosen from either (both not both) DL unified TCIs or UL TCIs (e.g., from a ul-TCI-StateList-r17 data structure of a BWP-UplinkDedicated IE). In yet other implementations, a list of unified TCI states for a separate TCI mode may be chosen from a mixture of DL unified TCI and UL unified TCI.

Alternatively, base station 222 may not explicitly configure UE 210 to measure specific resources (e.g., unified TCI states). In such implementations, UE 210 may determine a list of unified TCI states to monitor, and measure, based on which unified TCI states are configured by RRC signaling or unified TCI states activated by MAC-CE. In some implementations, the list of unified TCI states to monitor and measure may be limited to unified TCI states configured by RRC signaling. In other implementations, the list of unified TCI states to monitor and measure may be limited to unified TCI states activated by MAC-CEs.

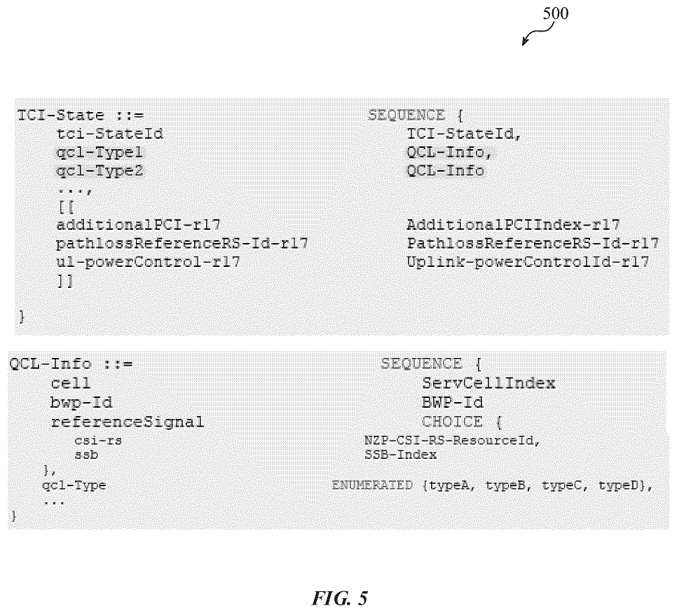

FIG. 5 is a diagram of an example 500 of transmission TCI with QCL information according to one or more implementations described herein. As shown, example 500 may include a TCI state IE that includes one or more QCL Info IE.

The TCI state IE may indicate a unified TCI state that includes a TCI state ID and signals associated with the unified TCI state. The QCL Info IE may correspond to a signal for UE 210 to monitor and measure for beam management purposes. The QCL Info IE include characteristics of a signal source, such as a serving cell index, bandwidth part (BWP) ID, reference signal type (e.g., CSI-RS), reference signal ID, and QCL type (e.g., typeA, typeB, typeC, and typeD).

Base station 222 may provide UE 210 with UE configuration information (e.g., a TCI state IE) that includes one or more unified TCI states for beam management purposes. In some implementations, when a TCI state IE includes two or more QCL sources, UE 210 may configured to only monitor, measure, and report signals of QCL type D. In other implementations, UE 210 may be configured to monitor, measure, and report signals of different QCL types (e.g., any combination of QCL type A-D). In some implementations, base station 222 may change which beams or signals are measured and reported by UE 210 via RRC signaling, DCI, MAC-CE, or another type of UE configuration information.

A preselected event, as described herein, may function as a trigger for UE 210 to generate a beam report and communicate the beam report to base station 222. A preselected event may correspond to changes in one or more signals of a unified TCI state. In some implementations, a preselected event may include UE 210 detecting that a unified TCI state has a better measured quality than an active TCI state. In some implementations, the preselected event includes a difference in measured quality amounts to a preselected event when a difference in quality exceeds a quality threshold.

In some implementations, a preselected event may include UE 210 detecting that a quality of an active TCI state is below a threshold. Additionally, or alternatively, a preselected event may include a difference in quality persisting beyond a predetermined threshold of time. In some implementations, one or more of a quality threshold, a difference in quality threshold, a time threshold, or another type of threshold may be configured by base station 222 via RRC, DCI, or MAC-CE. One or more thresholds may also, or alternatively, be defined according to a communication standard. Examples of a measured signal and/or a quality of a channel or signal may involve a RSRP and/or an SINR.

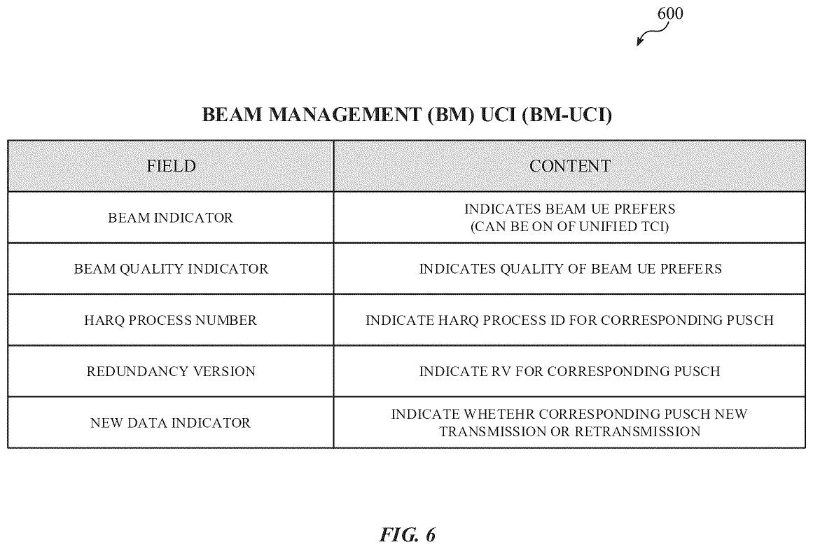

FIG. 6 is a diagram of an example 600 of UCI according to one or more implementations described herein. As shown, example, 600 may include a table representing fields and corresponding descriptions of information that may be included in UCI (also referred to as BM-UCI). A beam report may include UCI, and the UCI may include one or more of the fields and information represented in example 600.

A beam indicator may indicate a beam that UE 210 prefers and may be a beam of a unified TCI monitored by UE 210. A beam quality indicator may include an indication of a quality of a beam preferred by UE 210. Beam quality may relate to an RSRP, an SINR, and/or another type of measured characteristic. In some implementations, a beam quality may be reported together with each reported beam. In other implementations, a beam quality may not be reported together with each reported beam. Additionally, or alternatively, a beam quality indicator may include a capability index for each reported beam. A capability index (e.g., a CapabilityIndex) may indicate a maximum number of SRS ports. A HARQ process number may include an indication of a HARQ process ID for a corresponding PUSCH. A redundancy version (RV) may include an indication of a RV for a corresponding PUSCH. A new data indicator may include an indication of whether a corresponding PUSCH is a new transmission or a retransmission.

In some implementations, a pair of beams or multiple beams (e.g., a unified TCI state) may be reported. In such implementations, UE 210. May receive and/or transmit using both beams. In other implementations, a pair of beams or multiple beams may not be reported. In other implementations, UE 210 may measure and report a number (N) of beams or beam pairs. In such scenarios, N may be configured by base station and/or by communications standards implemented by UE 210.

A beta offset factor may be used to determine a number of resources for multiplexing different types of UCI in a PUSCH. Base station 222 may configure UE 210 to use one or more types of beta offsets via control information or another type of information. In some implementations, a common beta offset may be used for BM-UCI. For example, a beta offset used for another scenario (e.g., a beta offset generally applied to a CG, a beta offset applied to UTO, etc.) may be applied to UCI used for beam reporting. Examples of a common bet offset may be represented as follows.

$${β}_{offset}^{CG - UCI} or {β}_{offset}^{UTO - UCI}$$

In other implementations, a beta offset specialized for BM-UCI may be used. An example of such a best offset may be represented as follows.

$${β}_{offset}^{BM - UCI}$$

base station 222 may configure UE 210 to use a UCI used particularly for beam management and reporting (e.g., BM-UCI). In such implementations, base station 222 may configured a betta offset for BM-UCI than for other types of UCI.

Additionally, or alternatively, BM-UCI may only be carried by a UL CG of PUSCH resources. In some implementations, BM-UCI may be jointly encoded with a HARQ acknowledgment (HARQ-ACK). In such implementations, base station 222 may configure UE 210 about whether UE 210 is to jointly encode BM-UCI with HARQ-ACK. Additionally, or alternatively, when BM-UCI is jointly encoded or multiplex with HARQ-ACK, UE 210 may use a beta offset configured for HARQ-ACK (e.g., instead of a beta offset configured for BM-UCI or a beta offset configured for CG-UCI, UTO-UCI, etc.). In other implementations, UE 210 is not configured to jointly encode a HARQ-ACK with BM-UCI.

In scenarios where BM-UCI conflicts or collides with HARQ-ACK, and UE 210 is not configured to multiplex BM-UCI with HARQ-ACK, UE 210 may determine whether to drop (e.g., foregoing transmission) of the BM-UCI or HARQ-ACK. In some implementations, UE 210 may determine a priority associated with the BM-UCI (e.g., the PUSCH resources granted to carry the BM-UCI) and a priority associated with the HARQ-ACK. In some implementations, UE 210 may drop or forego transmitting the BM-UCI or the HARQ-ACK based on which one has the lower priority. Additionally, or alternatively, UE 210 may use the PUSCH resources to transmit whichever has the higher priority. In other implementations, when the HARQ-ACK has the same priority (or a greater priority) as the PUSCH for transmitting the BM-UCI, UE 210 may forego transmitting the BM-UCI via the PUSCH resources, and either use the PUSCH resources to transmit the HARQ-ACK or transmit the HARQ-ACK using PUSCH resources other than the PUSCH resources associated with the BM-UCI.

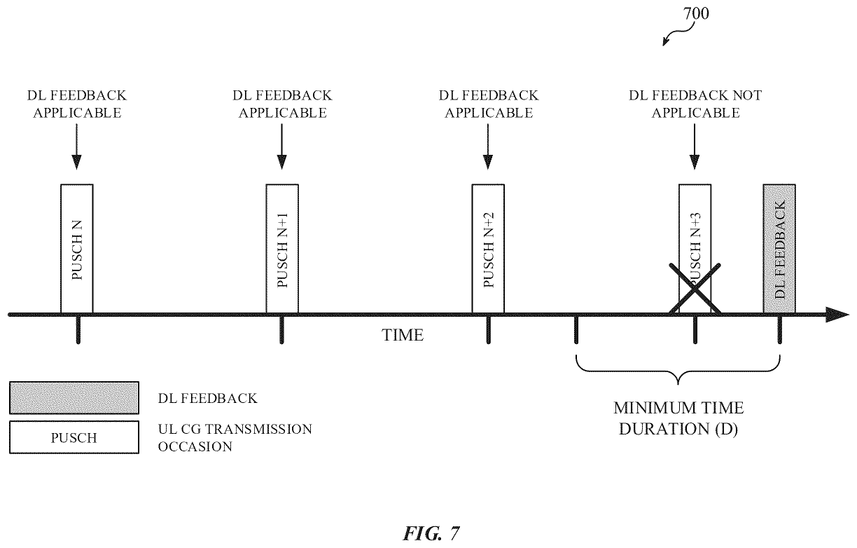

FIG. 7 is a diagram of an example 700 of DL feedback relative to UL CG transmission occasions according to one or more implementations described herein. As shown, example 700 may include time represented along a horizontal axis, PUSCH transmission occasions N though N+3, a preselected event between PUSCH N and PUSCH N+1, and DL feedback between following PUSCH N+3. PUSCH transmission occasions N though N+3 may be spaced according to a UL CG periodicity. For purposes of explaining example 700, assume that base station 222 provides UE 210 with the depicted UL CG. Assume also that UE 210 detects a preselected event and communicates a beam report to baes station 222, and that base station 222 responds by sending the DL feedback to UE 210 at some point after PUSCH transmission occasions N+3. In some implementations, the DL feedback may be applicable to PUSCH transmission occasions prior to the transmission of the DL feedback, except for PUSCH transmission occasions (e.g., PUSCH transmission occasion N+3) within a minimum time duration (D). The minimum time duration may be configured by base station 222 and may be measured from the transmission of the DL feedback.

In some implementations, base station 222 may provide configuration information to UE 210 indicating whether DL feedback is part of the beam management, beam reporting, and beam indication procedures discussed herein. This may be provided via UE configuration information or another type of configuration information. DL feedback may transmitted as DCI (e.g., using DCI Format 0_1). The DCI may involve cyclic redundancy check (CRC) scrambling using a special radio network temporary identifier (RNTI) designated for beam management (e.g., a BM-RNTI). In other implementations, the CRC may be scrambled using a configured scheduling (CS) RNTI (CS-RNTI). In such a scenario, a 1-bit field may be used in DCI Format 0_1 to indicate whether CRC scrambling is being applied to the DL feedback. In other implementations, a DL feedback information (DFI) flag of DCI Format 0_1 may be used. In the event of a size differential, a size of the DCI may be aligned with the other or existing DCI Format 0_1 by setting the other remaining bits to 0.

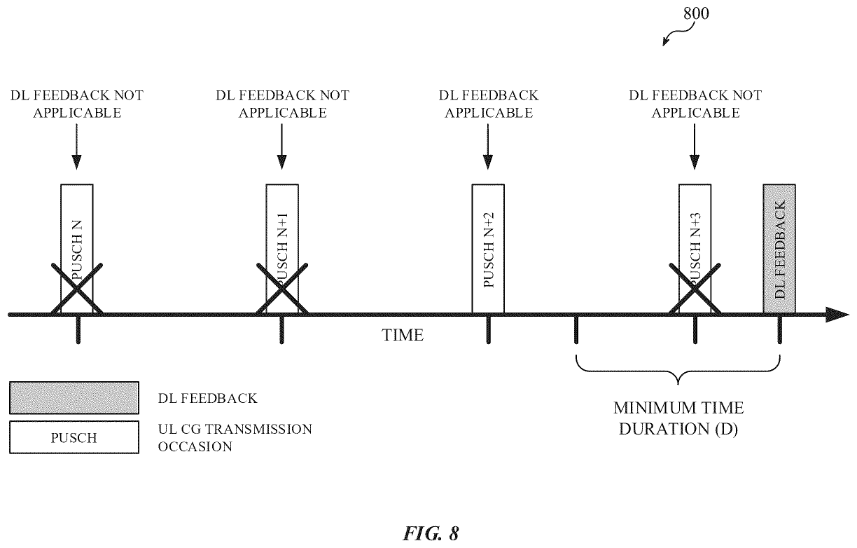

FIG. 8 is a diagram of an example 800 of DL feedback relative to UL CG transmission occasions according to one or more implementations described herein. As shown, example 800 may include time represented along a horizontal axis, PUSCH transmission occasions N though N+3, a preselected event between PUSCH N and PUSCH N+1, and DL feedback between following PUSCH N+3. PUSCH transmission occasions N though N+3 may be spaced according to a UL CG periodicity. For purposes of explaining example 800, assume that base station 222 provides UE 210 with the depicted UL CG. Assume also that UE 210 detects a preselected event and communicates a beam report to baes station 222, and that base station 222 responds by sending the DL feedback to UE 210 at some point after PUSCH transmission occasions N+3. In some implementations, the DL feedback may be applicable to the most recent PUSCH transmission occasion prior a minimum time duration (D) measured backward from the a transmission from the DL feedback. That is, the DL feedback may not be applicable to a prior PUSCH transmission occasion within the minimum time duration or to PUSCH transmission occasion prior to the otherwise most recent PUSCH transmission occasion. The minimum time duration may be configured by base station 222 and may be measured from the transmission of the DL feedback.

In some implementations, the DL feedback may be carried by DCI (e.g., by DCI Format 0_1). In such implementations the DCI may include an indication of the joint unified TCI state corresponding to the beam report and BM-UCI. The DCI may also, or alternatively, include one or more of the following: an indicator of the UL united TCI state; transmit power control (TPC) command for the PUSCH of the UL CG; and a bitmap for different HARQ processes. The bitmap may include 16 bits, and each bit may map to a different HARQ processes. A “1” may indicate that a corresponding HARQ process has been received, while a “0” may indicate that a corresponding HARQ process has not been received. In some implementations, the DCI may include an indicator of a unified TCI state. The indicated TCI state may be active after a certain or specified period of time. The period of time may be measured from a transmission time of the DL feedback. Base station 222 may configured UE 210 with the specified period of time using RRC signaling, DCI signaling, or MAC-CE. Alternatively, the specified period of time may be based on a communication standard implemented by UE 210. In some implementations, the specified period of time may be based on, or equal to, a minimum time duration provided to base station 222 via UE capability information.

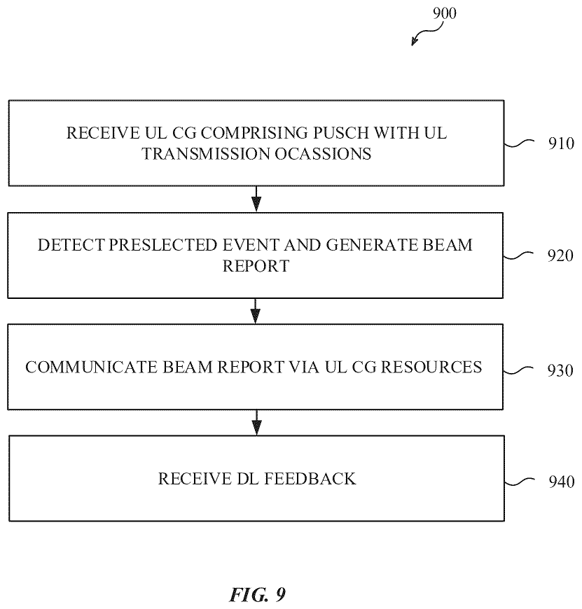

FIG. 9 is a diagram of an example process 900 for UE-initiated beam indication based on a UL CG according to one or more implementations described herein. Process 900 may be implemented by one or more baseband processors and/or UE 210. In some implementations, some or all of process 900 may be performed by one or more other systems or devices, including one or more of the devices of FIG. 2. Additionally, process 900 may include one or more fewer, additional, differently ordered and/or arranged operations than those shown in FIG. 9. In some implementations, some or all of the operations of process 900 may be performed independently, successively, simultaneously, etc., of one or more of the other operations of process 900. As such, the techniques described herein are not limited to a number, sequence, arrangement, timing, etc., of the operations or processes depicted in FIG. 9.

As shown, process 900 may include receiving a UL CG comprising a PUSCH with UL transmission occasions (block 910). For example, UE 210 may provide base station 210 with UE capability information. Base station 222 may respond by sending UE configuration information and/or a UL CG for beam management purposes. The UE configuration information may indicate one or more channels, signals, or beams that are to be monitored and measured by UE 210. The UE configuration information may also, or alternatively, include information and instructions to configure UE 210 generate a beam report for one or more beams, channels, or beams in response to one or more triggers, thresholds, and/or events.

Process 900 may also include detecting a preselected event and generating a beam report (block 920). A preselected event may include an event or condition indicated by configuration information provided by base station 210 or stored locally by UE 210 (based on an existing communication standard). A preselected event may include an occurrence of one or more conditions relating to a beam, channel, or signal (e.g., an SRS, SINR, etc.). The condition may relate to a beam characteristic, measured or detected by UE 210, falling below, equaling, or exceeding a corresponding threshold. UE 210 may generate a beam report in response to detecting the preselected event. The beam report may identify one or more beams and/or a status or one or more characteristics of a beam.

Process 900 may include communicating the beam report via the UL CG resources (block 930). For example, UE 210 may transmit the beam report to base station 210 using the time and frequency PUSCH resources during a transmission occasion of the UL CG provided by base station 222. The transmission occasion may be a transmission occasion immediately following the preselected event being detected and/or the beam report being generated. In some implementations, UE 210 may generate and provide a beam report in response to detecting a preselected event. In other implementations, UE 210 may generate and provide a beam report during each transmission occasion (regardless of whether a preselected event has been detected).

Process 900 may include receiving DL feedback (block 940). For example, UE 210 may receive DL feedback from base station 222. The DL feedback may include an acknowledgement of the beam report having been received by base station 222. In some implementations, UE 210 may retransmit the beam report until the DL feedback is received. In some implementations, so long as DL feedback is not received, UE 210 may retransmit the beam report until a maximum number of retransmissions has been reached. Example process 900 may further include one or more, or any combination, of additional operations, which may be described as an aspect, feature, or example of the techniques described herein.

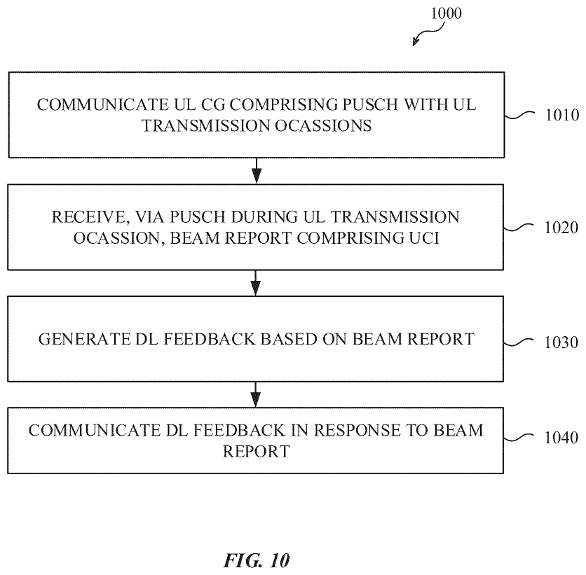

FIG. 10 is a diagram of an example process 1000 for UE-initiated beam indication based on a UL CG according to one or more implementations described herein. Process 1000 may be implemented by base station 222. In some implementations, some or all of process 1000 may be performed by one or more other systems or devices, including one or more of the devices of FIG. 2. Additionally, process 1000 may include one or more fewer, additional, differently ordered and/or arranged operations than those shown in FIG. 10. In some implementations, some or all of the operations of process 1000 may be performed independently, successively, simultaneously, etc., of one or more of the other operations of process 1000. As such, the techniques described herein are not limited to the number, sequence, arrangement, timing, etc., of the operations or processes depicted in FIG. 10.

As shown, process 1000 may include communicating a UL CG comprising PUSCH resources with UL transmission occasions (block 1010). For example, base station 222 may determine time and frequency resources of a PUSCH to allocate to UE 210, in addition to a periodicity and/or number of transmission occasions corresponding thereto. Base station 222 may generate a UL CG for allocating the resources and may send the UL CG to UE 210.

Process 1000 may include receiving, via the PUSCH and during a UL transmission occasion, a beam report comprising UCI (block 1020). For example, base station 222 may receive a beam report from UE 210 via the resources of the UL CG. The beam report may include UCI associated with one or more beams, channels, or signals, and status or measurement information corresponding thereto. The UCI may be associated with a beam from base station 222 and/or a beam from another base station 222.

Process 1000 may include generating DL feedback based on the beam report (block 1030). For example, base station 222 may generate DL feedback in response to the beam report from UE 210. The DL feedback may include an acknowledgement or confirmation that base station 222 received the beam report. In some implementations, the DL feedback may include additional information, such as instructions or configuration information that may cause UE 210 to engage in beam failure recovery, switch to another beam, channel, or signal, etc. Process 1000 may also include communicating the DL feedback in response to the beam report (block 1040). For example, base station 222 may communicate the DL feedback to UE 210. Example process 1000 may further include one or more, or any combination, of additional operations, which may be described as an aspect, feature, or example of the techniques described herein.

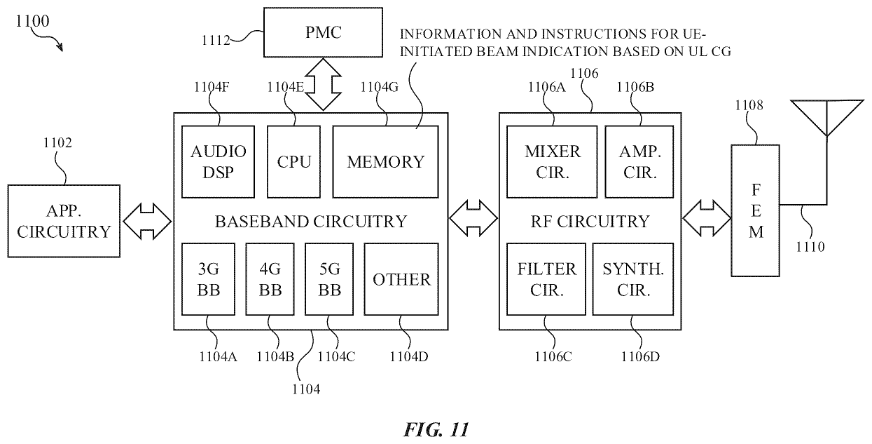

FIG. 11 is a diagram of an example of components of a device 1100 according to one or more implementations described herein. In some implementations, the device 1100 can include application circuitry 1102, baseband circuitry 1104, RF circuitry 1106, front-end module (FEM) circuitry 1108, one or more antennas 1110, and power management circuitry (PMC) 1112 coupled together at least as shown. The components of the illustrated device 1100 can be included in a UE or a RAN node. In some implementations, the device 1100 can include fewer elements (e.g., a RAN node may not utilize application circuitry 1102, and instead include a processor/controller to process IP data received from a CN or an Evolved Packet Core (EPC)). In some implementations, the device 1100 can include additional elements such as, for example, memory/storage, display, camera, sensor (including one or more temperature sensors, such as a single temperature sensor, a plurality of temperature sensors at different locations in device 1100, etc.), or input/output (I/O) interface. In other implementations, the components described below can be included in more than one device (e.g., said circuitries can be separately included in more than one device for Cloud-RAN (C-RAN) implementations).

The application circuitry 1102 can include one or more application processors. For example, the application circuitry 1102 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1100. In some implementations, processors of application circuitry 1102 can process IP data packets received from an EPC.

The baseband circuitry 1104 can include circuitry such as, but not limited to, one or more single-core or multi-core processors. The baseband circuitry 1104 can include one or more baseband processors or control logic to process baseband signals received from a receive signal path of the RF circuitry 1106 and to generate baseband signals for a transmit signal path of the RF circuitry 1106. Baseband circuitry 1104 can interface with the application circuitry 1102 for generation and processing of the baseband signals and for controlling operations of the RF circuitry 1106. For example, in some implementations, the baseband circuitry 1104 can include a 3G baseband processor 1104A, a 4G baseband processor 1104B, a 5G baseband processor 1104C, or other baseband processor(s) 1104D for other existing generations, generations in development or to be developed in the future (e.g., 5G, 6G, etc.). The baseband circuitry 1104 (e.g., one or more baseband processors 1104A-D) can handle various radio control functions that enable communication with one or more radio networks via the RF circuitry 1106. In other implementations, some or all of the functionality of baseband processors 1104A-D can be included in modules stored in the memory 1104G and executed via a Central Processing Unit (CPU) 1104E. The radio control functions can include, but are not limited to, signal modulation/demodulation, encoding/decoding, radio frequency shifting, etc. In some implementations, modulation/demodulation circuitry of the baseband circuitry 1104 can include Fast-Fourier Transform (FFT), precoding, or constellation mapping/de-mapping functionality. In some implementations, encoding/decoding circuitry of the baseband circuitry 1104 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1104G may receive and/or store information and instructions for enabling UE-initiated beam reporting or indication using a UL CG. Base station 222 may send the UL CG to UE 210 for beam reporting/indicating. The UL CG may correspond to time and frequency resources of a PUSCH with transmission occasions. UE 210 may detect a preselected event for beam reporting or indication, and in response to the preselected event, may generate a beam report. UE 210 may communicate the beam report to base station 222 using the PUSCH during a transmission occasion. The beam report may include UCI with measurement information for one or more beams. Base station 222 may receive the beam report, generate DL feedback based on the beam report, and communicate the DL feedback to UE 210. Many other aspects and examples are also described herein.

In some implementations, the baseband circuitry 1104 can include one or more audio digital signal processor(s) (DSP) 1104F. The audio DSPs 1104F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1104 and the application circuitry 1102 can be implemented together such as, for example, on a system on a chip (SOC).

In some implementations, the baseband circuitry 1104 can provide for communication compatible with one or more radio technologies. For example, in some implementations, the baseband circuitry 1104 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1104 is configured to support radio communications of more than one wireless protocol can be referred to as multi-mode baseband circuitry.

RF circuitry 1106 can enable communication with wireless networks using modulated electromagnetic radiation through a non-solid medium. In various implementations, the RF circuitry 1106 can include switches, filters, amplifiers, etc. to facilitate the communication with the wireless network. RF circuitry 1106 can include a receive signal path which can include circuitry to down-convert RF signals received from the FEM circuitry 1108 and provide baseband signals to the baseband circuitry 1104. RF circuitry 1106 can also include a transmit signal path which can include circuitry to up-convert baseband signals provided by the baseband circuitry 1104 and provide RF output signals to the FEM circuitry 1108 for transmission.

In some implementations, the receive signal path of the RF circuitry 1106 can include mixer circuitry 1106A, amplifier circuitry 1106B and filter circuitry 1106C. In some implementations, the transmit signal path of the RF circuitry 1106 can include filter circuitry 1106C and mixer circuitry 1106A. RF circuitry 1106 can also include synthesizer circuitry 1106D for synthesizing a frequency for use by the mixer circuitry 1106A of the receive signal path and the transmit signal path. In some implementations, the mixer circuitry 1106A of the receive signal path can be configured to down-convert RF signals received from the FEM circuitry 1108 based on the synthesized frequency provided by synthesizer circuitry 1106D. The amplifier circuitry 1106B can be configured to amplify the down-converted signals and the filter circuitry 1106C can be a low-pass filter (LPF) or band-pass filter (BPF) configured to remove unwanted signals from the down-converted signals to generate output baseband signals. Output baseband signals can be provided to the baseband circuitry 1104 for further processing. In some implementations, the output baseband signals can be zero-frequency baseband signals, although this is not a requirement. In some implementations, mixer circuitry 1106A of the receive signal path can comprise passive mixers, although the scope of the implementations is not limited in this respect.

In some implementations, the mixer circuitry 1106A of the transmit signal path can be configured to up-convert input baseband signals based on the synthesized frequency provided by the synthesizer circuitry 1106D to generate RF output signals for the FEM circuitry 1108. The baseband signals can be provided by the baseband circuitry 1104 and can be filtered by filter circuitry 1106C. In some implementations, the mixer circuitry 1106A of the receive signal path and the mixer circuitry 1106A of the transmit signal path can include two or more mixers and can be arranged for quadrature down conversion and up conversion, respectively. In some implementations, the mixer circuitry 1106A of the receive signal path and the mixer circuitry 1106A of the transmit signal path can include two or more mixers and can be arranged for image rejection (e.g., Hartley image rejection). In some implementations, the mixer circuitry 1106A of the receive signal path and the mixer circuitry ′1406A can be arranged for direct down conversion and direct up conversion, respectively. In some implementations, the mixer circuitry 1106A of the receive signal path and the mixer circuitry 1106A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1106 can include analog-to-digital converter (ADC) and digital-to-analog converter (DAC) circuitry and the baseband circuitry 1104 can include a digital baseband interface to communicate with the RF circuitry 1106.

In some dual-mode implementations, a separate radio IC circuitry can be provided for processing signals for each spectrum, although the scope of the implementations is not limited in this respect. In some implementations, the synthesizer circuitry 1106D can be a fractional-N synthesizer or a fractional N/N+1 synthesizer, although the scope of the implementations is not limited in this respect as other types of frequency synthesizers can be suitable. For example, synthesizer circuitry 1106D can be a delta-sigma synthesizer, a frequency multiplier, or a synthesizer comprising a phase-locked loop with a frequency divider.

The synthesizer circuitry 1106D can be configured to synthesize an output frequency for use by the mixer circuitry 1106A of the RF circuitry 1106 based on a frequency input and a divider control input. In some implementations, the synthesizer circuitry 1106D can be a fractional N/N+1 synthesizer.

In some implementations, frequency input can be provided by a voltage-controlled oscillator (VCO), although that is not a requirement. Divider control input can be provided by either the baseband circuitry 1104 or the applications circuitry 1102 depending on the desired output frequency. In some implementations, a divider control input (e.g., N) can be determined from a look-up table based on a channel indicated by the applications circuitry 1102.

Synthesizer circuitry 1106D of the RF circuitry 1106 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1106D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1106 can include an IQ/polar converter.

FEM circuitry 1108 can include a receive signal path which can include circuitry configured to operate on RF signals received from one or more antennas 1110, amplify the received signals and provide the amplified versions of the received signals to the RF circuitry 1106 for further processing. FEM circuitry 1108 can also include a transmit signal path which can include circuitry configured to amplify signals for transmission provided by the RF circuitry 1106 for transmission by one or more of the one or more antennas 1110. In various implementations, the amplification through the transmit or receive signal paths can be done solely in the RF circuitry 1106, solely in the FEM circuitry 1108, or in both the RF circuitry 1106 and the FEM circuitry 1108.

In some implementations, the FEM circuitry 1108 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1106). The transmit signal path of the FEM circuitry 1108 can include a power amplifier (PA) to amplify input RF signals (e.g., provided by RF circuitry 1106), and one or more filters to generate RF signals for subsequent transmission (e.g., by one or more of the one or more antennas 1110).

In some implementations, the PMC 1112 can manage power provided to the baseband circuitry 1104. In particular, the PMC 1112 can control power-source selection, voltage scaling, battery charging, or DC-to-DC conversion. The PMC 1112 can often be included when the device 1100 is capable of being powered by a battery, for example, when the device is included in a UE. The PMC 1112 can increase the power conversion efficiency while providing desirable implementation size and heat dissipation characteristics.

While FIG. 11 shows the PMC 1112 coupled only with the baseband circuitry 1104. However, in other implementations, the PMC 1112 may be additionally or alternatively coupled with, and perform similar power management operations for, other components such as, but not limited to, application circuitry 1102, RF circuitry 1106, or FEM circuitry 1108.

In some implementations, the PMC 1112 can control, or otherwise be part of, various power saving mechanisms of the device 1100. For example, if the device 1100 is in an RRC_Connected state, where it is still connected to the RAN node as it expects to receive traffic shortly, then it can enter a state known as Discontinuous Reception Mode (DRX) after a period of inactivity. During this state, the device 1100 can power down for brief intervals of time and thus save power.

If there is no data traffic activity for an extended period of time, then the device 1100 can transition off to an RRC_Idle state, where it disconnects from the network and does not perform operations such as channel quality feedback, handover, etc. The device 1100 goes into a very low power state and it performs paging where again it periodically wakes up to listen to the network and then powers down again. The device 1100 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1102 and processors of the baseband circuitry 1104 can be used to execute elements of one or more instances of a protocol stack. For example, processors of the baseband circuitry 1104, alone or in combination, can be used execute Layer 3, Layer 2, or Layer 1 functionality, while processors of the baseband circuitry 1104 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

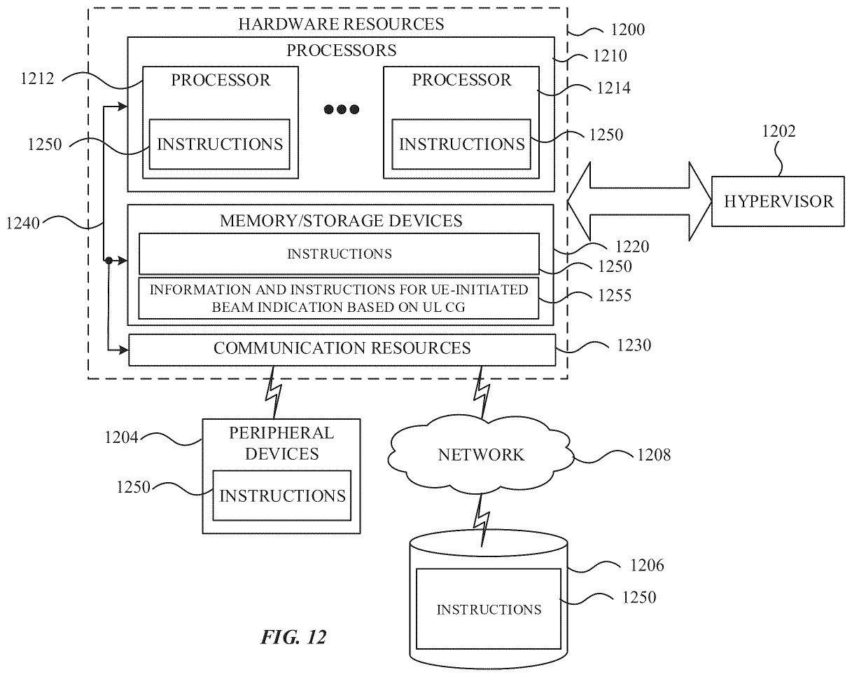

FIG. 12 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors (or processor cores) 1210, one or more memory/storage devices 1220, and one or more communication resources 1230, each of which may be communicatively coupled via a bus 1240. For implementations where node virtualization (e.g., NFV) is utilized, a hypervisor may be executed to provide an execution environment for one or more network slices/sub-slices to utilize the hardware resources 1200.

The processors 1210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1212 and a processor 1214.

The memory/storage devices 1220 may include main memory, disk storage, or any suitable combination thereof. The memory/storage devices 1220 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1220 receive and/or store information and instructions 1255 for enabling UE-initiated beam reporting or indication using a UL CG. Base station 222 may send the UL CG to UE 210 for beam reporting/indicating. The UL CG may correspond to time and frequency resources of a PUSCH with transmission occasions. UE 210 may detect a preselected event for beam reporting or indication, and in response to the preselected event, may generate a beam report. UE 210 may communicate the beam report to base station 222 using the PUSCH during a transmission occasion. The beam report may include UCI with measurement information for one or more beams. Base station 222 may receive the beam report, generate DL feedback based on the beam report, and communicate the DL feedback to UE 210. Many other aspects and examples are also described herein.

The communication resources 1230 may include interconnection or network interface components or other suitable devices to communicate with one or more peripheral devices 1204 or one or more databases 1206 via a network 1208. For example, the communication resources 1230 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1200 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a baseband circuitry may comprise: a memory; and one or more processors configured to, when executing instructions stored in the memory, cause the one or more processors to: receive, via radio frequency (RF) circuitry, an uplink (UL) configured grant (CG) from a base station, the UL CG comprising physical UL shared channel (PUSCH) resources and a plurality of UL transmission occasions; generate, in response to detecting a preselected event, UL control information (UCI) comprising a beam report for a downlink (DL) and/or uplink (UL) beam; and communicate, via the RF circuitry, the UCI to the base station during a UL transmission occasion of the a plurality of UL transmission occasions.

In example 2, which may also include one or more of the examples described herein, the baseband processor is part of a user equipment (UE).

In example 3, which may also include one or more of the examples described herein, the one or more processors are configured to: receive the UL CG exclusively via radio resource control (RRC) signaling; receive the UL CG exclusively via downlink (DL) control information (DCI) signaling; receive the UL CG via either RRC signaling or DCI signaling.

In example 4, which may also include one or more of the examples described herein, the preselected event comprises detecting a quality of a beam meeting an event triggering condition exceeding a quality threshold relative to a quality of another beam.

In example 5, which may also include one or more of the examples described herein, the preselected event comprises the UL transmission occasion of the plurality of UL transmission occasions.

In example 6, which may also include one or more of the examples described herein, the one or more processors are further configured to: communicate, via the RF circuitry, the UCI during the UL transmission occasion, regardless of having other UL data to communicate to the base station.

In example 7, which may also include one or more of the examples described herein, the one or more processors are further configured to: communicate, via the RF circuitry, the UCI during the UL transmission occasion, conditioned upon having other UL data to communicate to the base station.

In example 8, which may also include one or more of the examples described herein, the preselected event comprises a CG-UCI to be reported to the base station in combination with the UCI.

In example 9, which may also include one or more of the examples described herein, the one or more processors are further configured to: communicate, via the RF circuitry, the UCI during the UL transmission occasion, regardless of having CG-UCI to send to the base station.

In example 10, which may also include one or more of the examples described herein, the one or more processors are further configured to: communicate, via the RF circuitry, the UCI, comprising the beam report, with CG unused transmission occasion (UTO) information.

In example 11, which may also include one or more of the examples described herein, the one or more processors are further configured to: communicate, via the RF circuitry, the UCI, comprising the beam report, regardless of having CG unused transmission occasion (UTO) information to communicate to the base station.

In example 12, which may also include one or more of the examples described herein, the one or more processors are further configured to: receive, from the base station via the RF circuitry, instructions for measuring one or more TCI states; and perform measurements on the one or more TCI states, and the UCI comprises the measurements of the one or more TCI states.

In example 13, which may also include one or more of the examples described herein, the one or more processors are further configured to: determine a list of unified TCI states based on one or more TCI states activated by radio resource control (RRC) signaling or media access control (MAC) control element (MAC-CE) signaling; and perform measurements on the list of unified TCI states, and the UCI comprises the measurements associated with the list of unified TCI states.

In example 14, which may also include one or more of the examples described herein, the UL CG is associated with a unified TCI state with two sources of quasi co-location (QCL) information.

In example 15, which may also include one or more of the examples described herein, the preselected event comprises at least one of: an inactive unified TCI state having better measurements than an active TCI state, or a level of quality of an active TCI state failing to satisfy a corresponding threshold.

In example 16, which may also include one or more of the examples described herein, the level of quality is based on at least one of: a reference signal receive power (RSRP) measurement; or a signal-to-interference-plus-noise ratio (SINR), and the corresponding threshold is configured by at least one of: RRC signaling, MAC-CE signaling, or DCI signaling.

In example 17, which may also include one or more of the examples described herein, the UCI comprises at least one of: a beam indicator, a beam quality indicator, a hybrid automatic repeat request (HARQ) number, a redundancy version, or an indication of whether the UCI corresponds to a new PUSCH transmission or a PUSCH retransmission.

In example 18, which may also include one or more of the examples described herein, the UCI is configured to include reporting information for a single beam.

In example 19, which may also include one or more of the examples described herein, the UCI includes a capability index for each beam reported, the capability index indicating a maximum number of sounding reference signal (SRS) ports.

In example 20, which may also include one or more of the examples described herein, the UCI includes an indication of a reported beam and a beam quality of the reported beam, the beam quality comprising at least one of: a RSRP associated with the reported beam; or an SINR associated with the reported beam.

In example 21, which may also include one or more of the examples described herein, the base station configures a separate beta offset to determine an amount of resources used for encoding the UCI.

In example 22, which may also include one or more of the examples described herein, existing beta offset configured by the base station is used to determine the amount of resources used for encoding the UCI.

In example 23, which may also include one or more of the examples described herein, the UCI is jointly encoded with a hybrid automatic repeat request (HARQ) acknowledgement (HARQ-ACK).

In example 24, which may also include one or more of the examples described herein, when UL transmission of the UCI via a PUSCH conflicts with UL transmission of a hybrid automatic repeat request (HARQ) acknowledgement (HARQ-ACK) signal, when the PUSCH has a same priority as the HARQ-ACK signal, the PUSCH is not transmitted, and the HARQ-ACK signal is transmitted via a physical UL control channel (PUCCH) or a different PUSCH; when the PUSCH has a different priority as the HARQ-ACK signal, the PUSCH or the HARQ-ACK signal having a lower priority is dropped.

In example 25, which may also include one or more of the examples described herein, the one or more processors are further configured to: receive, via the RF circuitry and in response to the UCI, downlink (DL) feedback from the base station.

In example 26, which may also include one or more of the examples described herein, the DL feedback comprises DCI with a cyclic redundancy check (CRC) scrambled by a beam management (BM) radio network temporary identifier (RNTI) (BM-RNTI).

In example 27, which may also include one or more of the examples described herein, the DL feedback comprises DCI with a CRC scrambled by a configured scheduling (CS) RNTI (CS-RNTI).

In example 28, which may also include one or more of the examples described herein, the DL feedback comprises DCI that includes at least one of: an indication of a joint unified TCI state; an indication of a UL unified TCI state; a bitmap configured to indicate one or more success HARQ processes and one or more unsuccessful HARQ processes; or a transmit power control (TPC) command for the PUSCH of the UL CG.

In example 29, which may also include one or more of the examples described herein, the DL feedback comprises DCI that includes a unified TCI state indicator associated with at least one TCI state, and the at least one TCI state to become active upon expiration of a duration, measured from a transmission or reception time of the DCI, the duration comprising at least one of: an amount of time defined by a communication standard, an amount of time configured by RRC signaling, or a minimum time duration reported as UE capability information.

In example 30, which may also include one or more of the examples described herein, the DL feedback comprises DCI applicable to all UL CG transmission prior to a configured duration (D) as measured from a transmission or reception time of the DCI.

In example 31, which may also include one or more of the examples described herein, the DL feedback comprises DCI only applicable to a most recent UL CG transmission that is prior to a configured duration (D) as measured from a transmission or reception time of the DCI.

In example 32, which may also include one or more of the examples described herein, a user equipment (UE), comprising: a memory; and one or more processors configured to, when executing instructions stored in the memory, cause the one or more processors to: receive an uplink (UL) configured grant (CG) from a base station, the UL CG comprising physical UL shared channel (PUSCH) resources and a plurality of UL transmission occasions; generate, in response to detecting a preselected event, UL control information (UCI) comprising a beam report for a downlink (DL) beam and/or uplink (UL) beam; and communicate the UCI to the base station during a UL transmission occasion of the a plurality of UL transmission occasions.

In example 33, which may also include one or more of the examples described herein, a method, performed by a user equipment (UE), may comprise: receiving an uplink (UL) configured grant (CG) from a base station, the UL CG comprising physical UL shared channel (PUSCH) resources and a plurality of UL transmission occasions; generating, in response to detecting a preselected event, UL control information (UCI) comprising a beam report for a downlink (DL) beam and/or uplink (UL) beam; and communicating the UCI to the base station during a UL transmission occasion of the a plurality of UL transmission occasions.

In example 34, which may also include one or more of the examples described herein, a base station, comprising: radio frequency (RF) circuitry; a memory; and one or more processors configured to, when executing instructions stored in the memory, cause the one or more processors to cause the base station to: communicate, to a user equipment (UE), an uplink (UL) configured grant (CG) comprising physical UL shared channel (PUSCH) resources and a plurality of UL transmission occasions; receive, from the UE and during a UL transmission occasion of the plurality of UL transmission occasions, UL control information (UCI) comprising a beam report for a downlink (DL) beam and/or uplink (UL) beam; generate, based on the UCI, a downlink (DL) feedback; and communicate, to the UE, the DL feedback.

In example 35, which may also include one or more of the examples described herein, a method, performed by a base station, may comprise: communicating, to a user equipment (UE), an uplink (UL) configured grant (CG) comprising physical UL shared channel (PUSCH) resources and a plurality of UL transmission occasions; receiving, from the UE and during a UL transmission occasion of the plurality of UL transmission occasions, UL control information (UCI) comprising a beam report for a downlink (DL) beam and/or uplink (UL) beam; generating, based on the UCI, a downlink (DL) feedback; and communicating, to the UE, the DL feedback.

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A baseband circuitry, comprising:
a memory; and
one or more processors configured to, when executing instructions stored in the memory, cause the one or more processors to:
receive, via radio frequency (RF) circuitry, an uplink (UL) configured grant (CG) from a base station, the UL CG indicating physical UL shared channel (PUSCH) resources and a plurality of UL transmission occasions;
generate, in response to detecting a preselected event, UL control information (UCI) comprising a beam report for a downlink (DL) and/or uplink (UL) beam; and
communicate, via the RF circuitry and the PUSCH, the UCI to the base station during a UL transmission occasion of the plurality of UL transmission occasions.

2. The baseband circuitry of claim 1, wherein the baseband processor is part of a user equipment (UE).

3. The baseband circuitry of claim 1, wherein the one or more processors are configured to:
receive the UL CG exclusively via radio resource control (RRC) signaling;
receive the UL CG exclusively via downlink (DL) control information (DCI) signaling;
receive the UL CG via either RRC signaling or DCI signaling.

4. The baseband circuitry of claim 1, wherein the preselected event comprises detecting a quality of a beam meeting an event triggering condition exceeding a quality threshold relative to a quality of another beam.

5. The baseband circuitry of claim 1, wherein the preselected event comprises the UL transmission occasion of the plurality of UL transmission occasions.

6. The baseband circuitry of claim 1, wherein the one or more processors are further configured to:
communicate, via the RF circuitry, the UCI during the UL transmission occasion, regardless of having other UL data to communicate to the base station.

7. The baseband circuitry of claim 1, wherein the one or more processors are further configured to:
communicate, via the RF circuitry, the UCI during the UL transmission occasion, conditioned upon having other UL data to communicate to the base station.

8. The baseband circuitry of claim 1, wherein the preselected event comprises a CG-UCI to be reported to the base station in combination with the UCI.

9. The baseband circuitry of claim 1, wherein the one or more processors are further configured to:
communicate, via the RF circuitry, the UCI during the UL transmission occasion, regardless of having CG-UCI to send to the base station.

10. The baseband circuitry of claim 1, wherein the one or more processors are further configured to:
communicate, via the RF circuitry, the UCI, comprising the beam report, with CG unused transmission occasion (UTO) information.

11. The baseband circuitry of claim 1, wherein the one or more processors are further configured to:
communicate, via the RF circuitry, the UCI, comprising the beam report, regardless of having CG unused transmission occasion (UTO) information to communicate to the base station.

12. The baseband circuitry of claim 1, wherein:
the one or more processors are further configured to:
receive, from the base station via the RF circuitry, instructions for measuring one or more TCI states; and
perform measurements on the one or more TCI states, and
the UCI comprises the measurements of the one or more TCI states.

13. The baseband circuitry of claim 1, wherein:
the one or more processors are further configured to:
determine a list of unified TCI states based on one or more TCI states activated by radio resource control (RRC) signaling or media access control (MAC) control element (MAC-CE) signaling; and
perform measurements on the list of unified TCI states, and
the UCI comprises the measurements associated with the list of unified TCI states.

14. The baseband circuitry of claim 1, wherein the UL CG is associated with a unified TCI state with two sources of quasi co-location (QCL) information.

15. The baseband circuitry of claim 1, wherein the preselected event comprises at least one of:
an inactive unified TCI state having better measurements than an active TCI state, or
a level of quality of an active TCI state failing to satisfy a corresponding threshold.

16. The baseband circuitry of claim 1, wherein:
the level of quality is based on at least one of:
a reference signal receive power (RSRP) measurement; or
a signal-to-interference-plus-noise ratio (SINR), and
the corresponding threshold is configured by at least one of:
RRC signaling,
MAC-CE signaling, or
DCI signaling.

17. A user equipment (UE), comprising:
a memory; and
one or more processors configured to, when executing instructions stored in the memory, cause the one or more processors to:
receive an uplink (UL) configured grant (CG) from a base station, the UL CG comprising physical UL shared channel (PUSCH) resources and a plurality of UL transmission occasions;
generate, in response to detecting a preselected event, UL control information (UCI) comprising a beam report for a downlink (DL) beam and/or uplink (UL) beam; and
communicate, via the PUSCH, the UCI to the base station during a UL transmission occasion of the a plurality of UL transmission occasions.

18. The UE of claim 17, wherein the UL CG is associated with a unified TCI state with two sources of quasi co-location (QCL) information.

19. A base station, comprising:
radio frequency (RF) circuitry;
a memory; and
one or more processors configured to, when executing instructions stored in the memory, cause the one or more processors to:
communicate, to a user equipment (UE), an uplink (UL) configured grant (CG) comprising physical UL shared channel (PUSCH) resources and a plurality of UL transmission occasions;
receive, from the UE, via the PUSCH, and during a UL transmission occasion of the plurality of UL transmission occasions, UL control information (UCI) comprising a beam report for a downlink (DL) beam and/or uplink (UL) beam;
generate, based on the UCI, a downlink (DL) feedback; and
communicate, to the UE, the DL feedback.

20. The base station of claim 19, wherein the preselected event comprises a CG-UCI that is reported to the base station in combination with the UCI.
